(19) United States
(12) Patent Application Publication
(10) Pub. No.: US 2026/0257553 A1
(43) Pub. Date: Sep. 3, 2026

(54) DISPLAY DEVICE FOR VEHICLE AND METHOD FOR CONTROLLING SAME

(71) Applicant: LG ELECTRONICS INC., Seoul (KR)

(72) Inventors: Soohwan OH, Seoul (KR); Donghwan KIM, Seoul (KR)

(73) Assignee: LG ELECTRONICS INC., Seoul (KR)

(21) Appl. No.: 18/873,117

(22) PCT Filed: Jul. 6, 2022
(86) PCT No.: PCT/KR2022/009710

§ 371 Date: Dec. 9, 2024

(51) Int. Cl. B60K 35/10; B60K 35/22; B60K 35/81

(52) U.S. Cl. CPC B60K 35/10; B60K 35/22; B60K 35/81; B60K 2360/1438; B60K 2360/1472; B60K 2360/166; B60K 2360/566

(57) ABSTRACT

The present disclosure relates to recognizing a user command in a display device for a vehicle capable of communicating with an external device, and may provide a display device for a vehicle comprising: a display unit; a user input unit; an in-vehicle client that communicates with an external device for executing an application for the external device to receive a first execution screen of the application for the external device from the external device and display same on the display unit, and receives a gesture list for the external device related to the first execution screen from the external device to generate a gesture recognition criterion for the external device; and a gesture recognizer that recognizes a gesture inputted through the user input unit while the first execution screen is displayed, on the basis of the gesture recognition criterion for the external device.

### TECHNICAL FIELD

The present disclosure relates to user command recognition in a vehicle display device capable of communicating with an external device.

### BACKGROUND ART

For safety and convenience of a user who uses a vehicle, various sensors and devices are disposed at the vehicle, and functions of the vehicle are diversified. The functions of the vehicle may be divided into a convenience function for promoting driver's convenience, and a safety function for enhancing safety of the driver and/or pedestrians.

The convenience function of the vehicle has a development motive associated with the driver's convenience, such as providing infotainment (information +entertainment) to the vehicle, supporting a partially autonomous driving function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function of the vehicle is a technique of ensuring safeties of the driver and/or pedestrians, and may include various functions, such as a lane departure warning system (LDWS), a lane keeping assist system (LKAS), an autonomous emergency braking (AEB), and the like.

Recently, a vehicle may communicate with an external device such as a driver's smartphone, receive an execution screen (e.g., a navigation app execution screen) of an application executed in the smartphone, and display the received execution screen on a display device (e.g., a Center Information Display (CID), a cluster, etc.) of the vehicle. In this case, a prescribed user command for controlling the application executed in the smartphone may be inputted through the vehicle display device. For example, it is assumed that the user command is a pinch touch gesture for performing a zoom control on an execution screen (e.g., a map screen) of a navigation application executed in the smartphone.

However, a separate genuine navigation application may be installed in the vehicle itself, and a touch gesture (e.g., a double tap touch gesture) to perform a zoom control on the map screen of the genuine navigation application may be different from the pinch touch gesture.

Therefore, the driver may have to input a different type of a touch gesture to execute the same operation or function (e.g., zoom control), depending on whether the executed application is executed in the smartphone or the vehicle.

Also, various types of external devices (e.g., IOS smartphone, Android smartphone, etc.) may be connected to the vehicle. Depending on the type of the external device connected to the vehicle, a different type of touch gesture may have to be inputted in the vehicle despite intending to execute a certain same function.

This may cause considerable confusion for the driver.

### DISCLOSURE

### Technical Tasks

One technical task of the present disclosure is to provide a vehicle display device and method of controlling the same, thereby remotely controlling an external device through the vehicle display device for an application executed in the external device communicatively connected to the vehicle display device.

Another technical task of the present disclosure is to provide a vehicle display device and method of controlling the same, thereby controlling an application executed in the vehicle display device or an external device connected thereto with the same user command for the same function of the application no matter where the application is executed.

### Technical Solutions

In one technical aspect of the present disclosure, provided is a vehicle display device including a display unit, a user input unit, a vehicle client configured to receive a first execution screen of an external device application from an external device by communicating with the external device executing the external device application, display the first execution screen on the display unit, and generate an external device gesture recognition reference by receiving an external device gesture list relating to the first execution screen from the external device, and a gesture identifier identifying a gesture inputted through the user input unit based on the external device gesture recognition reference while the first execution screen is displayed.

The display unit and the user input unit may include a touchscreen, the inputted gesture may be a touch gesture, and the external device gesture list may be a touch gesture list.

Based on the touch gesture related to the external device gesture recognition reference, the vehicle client may transmit information on the touch gesture to the external device, receive a second execution screen of the external device application related to the touch gesture, and display the second execution screen on the display unit.

The vehicle client may receive an external device gesture list relating to the second execution screen.

The vehicle display device may further include an app executor configured to execute a vehicle application and display a third execution screen of the vehicle application on the touchscreen, and the gesture recognizer may identify a touch gesture inputted through the touchscreen based on a pre-stored vehicle gesture recognition reference while the third execution screen is displayed.

Based on the touch gesture related to the vehicle gesture recognition reference, the app executor may display a fourth execution screen of the vehicle application related to the touch gesture on the touchscreen.

The vehicle client may further receive an external device function list relating to a function supported by the external device from the external device, and at least some items of the external device function list may be related to the external device touch gesture list.

The vehicle client may generate an integrated function and touch gesture list based on the external device function list, the external device touch gesture list, a previously stored vehicle function list, and a previously stored vehicle touch gesture list, and at least some items of the vehicle function list may be related to the vehicle touch gesture list.

Although any of the first execution screen of the external device application and the third execution screen of the vehicle application is displayed on the display unit, the gesture recognizer may identify a touch gesture inputted through the touchscreen based on an integrated gesture recognition reference related to the integrated function and touch gesture list.

The integrated function and touch gesture list may further include information on whether each touch gesture is related to any one of the external device and the app executor.

The integrated function and touch gesture list may be differently generated according to a priority between the external device and the vehicle display device.

The priority may be automatically set according to a comparison between a use time of an execution screen of the external device application and a use time of an execution screen of the vehicle application.

The integrated function and touch gesture list may be generated differently according to any one of a model of the external device, a type of the external application, and an execution screen of the external application.

Although communication between the external device and the vehicle client is released, the gesture recognizer may identify a touch gesture inputted through the touchscreen based on an integrated gesture recognition reference related to the integrated function and touch gesture list.

Based on releasing the communication between the external device and the vehicle client, a touch gesture inputted through the touchscreen may be identified based on a previously stored vehicle function list and a previously stored vehicle touch gesture list.

The vehicle client may be configured to communicate with a different external device, receive a function list and a touch gesture list for the different external device, and update the integrated function and touch gesture list based on the received function list and the received touch gesture list.

With respect to the external device, the different external device, and an app executor for executing a vehicle application, the gesture recognizer may identify a touch gesture inputted through the touchscreen based on an integrated gesture recognition reference related to the updated integrated function and touch gesture list.

Based on identifying the touch gesture inputted through the touchscreen while the first execution screen of the external device application is displayed, an identifier of the touch gesture may be transmitted to the external device.

Based on identifying the touch gesture inputted through the touchscreen while the third execution screen of the vehicle application is displayed, an identifier of the touch gesture may be transmitted to an app executor executing the vehicle application.

In another technical aspect of the present disclosure, provided is a method of controlling a vehicle display device, the method including receiving to display a first execution screen of an external device application from an external device by communicating with the external device executing the external device application, generating an external device gesture recognition reference by receiving an external device gesture list relating to the first execution screen from the external device, and identifying a gesture inputted through a user input unit based on the external device gesture recognition reference while the first execution screen is displayed.

### Advantageous Effects

Effects of a vehicle display device and method of controlling the same according to the present disclosure will be described as follows.

According to at least one of embodiments of the present disclosure, there is an advantage in that an external device may be remotely controlled through the vehicle display device for an application executed in the external device connected to the vehicle display device.

In addition, according to at least one of the embodiments of the present disclosure, an application executed in the vehicle display device or an external device connected thereto may be controlled with the same user command for the same function of the application no matter where the application is executed.

### DESCRIPTION OF DRAWINGS

FIGS. 1 and 2 illustrate the exterior of a vehicle according to an embodiment of the present disclosure.

FIGS. 3 and 4 illustrate the interior of a vehicle according to an embodiment of the present disclosure.

FIG. 5 is a block diagram referenced to describe a vehicle related to an embodiment of the present disclosure.

FIG. 6 illustrates that an application execution screen of an external device is transmitted to a vehicle display device and then displayed thereon according to an embodiment of the present disclosure.

FIG. 7 is a flowchart for a mutual operation between the vehicle display device and the external device according to an embodiment of the present disclosure.

FIG. 8 is a flowchart for a mutual operation between the vehicle display device and the external device according to an embodiment of the present disclosure.

FIG. 9 is a flowchart for an operation of a vehicle display device according to an embodiment of the present disclosure.

FIG. 10 is a flowchart for a mutual operation between a vehicle display device and an external device according to an embodiment of the present disclosure.

FIGS. 11 and 12 illustrate examples of functions and touch gestures according to FIG. 10.

FIG. 13 is a flowchart for generating an integrated gesture recognition rule of FIG. 12.

FIG. 14 is a flowchart for a mutual operation between a vehicle display device and a plurality of external devices according to an embodiment of the present disclosure.

FIG. 15 illustrates an example of a function and a touch gesture according to FIG. 14.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings.

Each of these elements may be configured as a separate individual hardware module or implemented as two or more hardware modules. Two or more elements may be implemented as a single hardware module. In some cases, at least one of these elements may be implemented as software.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions, or steps, disclosed in the specification, and it is also understood that greater or fewer components, functions, or steps may likewise be utilized.

Hereinafter, the embodiments of the present disclosure will be described in detail with reference to the accompanying drawings and the content described in the accompanying drawings. However, the present disclosure is not limited or restricted by the embodiments.

The terms used in this specification are selected from widely used general terms in consideration of the functions in the present disclosure. However, the terms may vary according to the intention or practice of those skilled in the art or the emergence of new technologies. In specific cases, terms arbitrarily selected by the applicant are also used, and in such cases, the meaning will be described in the corresponding part of the disclosure. Therefore, it should be noted that the terms used in this specification should be interpreted based on the substantial meanings the terms have and the overall content of this specification, rather than the simple names of the terms.

The vehicle described in the present disclosure may encompass concepts including automobiles and motorcycles. Hereinafter, the description will primarily focus on automobiles.

The vehicle described in the present disclosure may encompass various types of vehicles including an internal combustion engine vehicle with an engine as the power source, a hybrid vehicle with both an engine and an electric motor as the power source, and an electric vehicle with an electric motor as the power source.

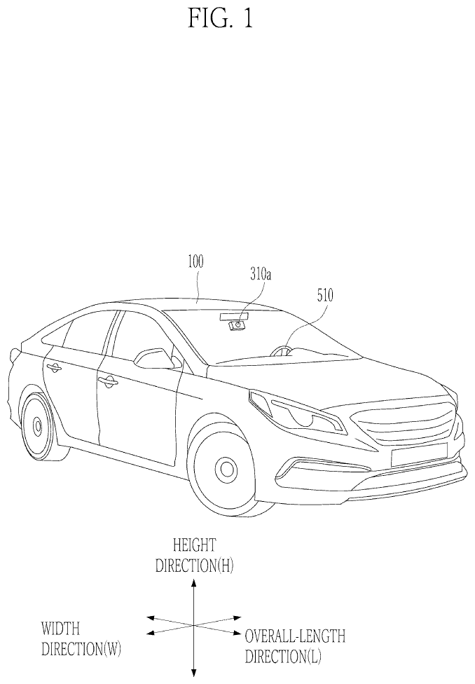

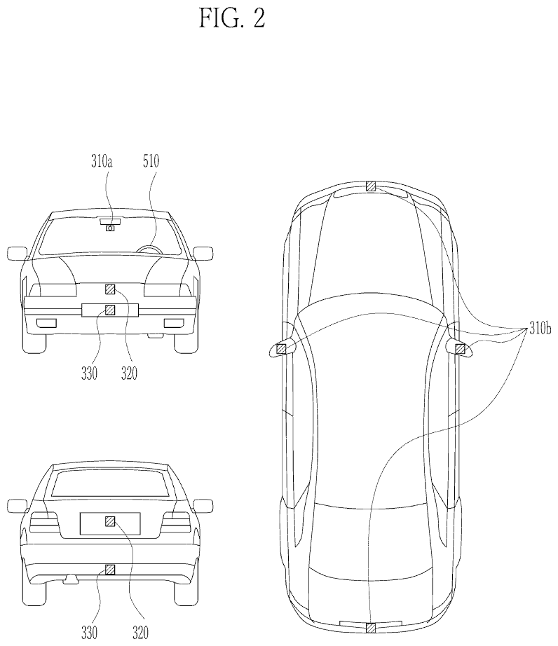

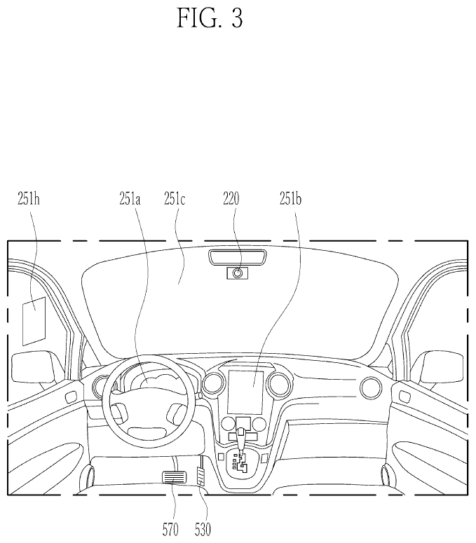

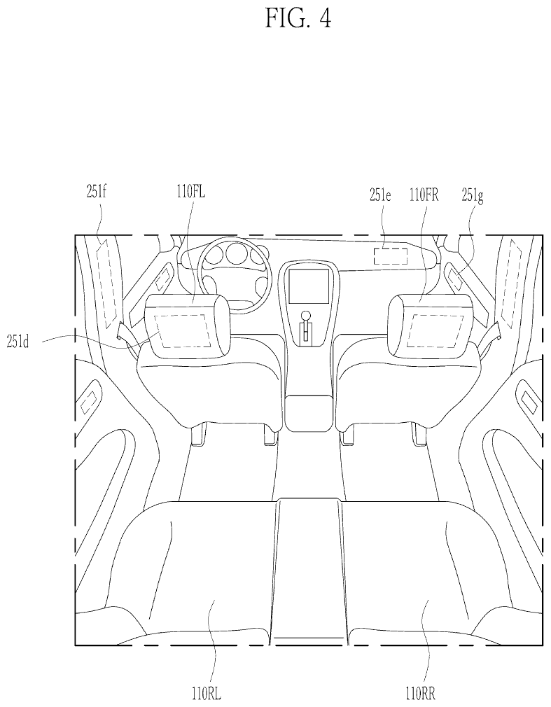

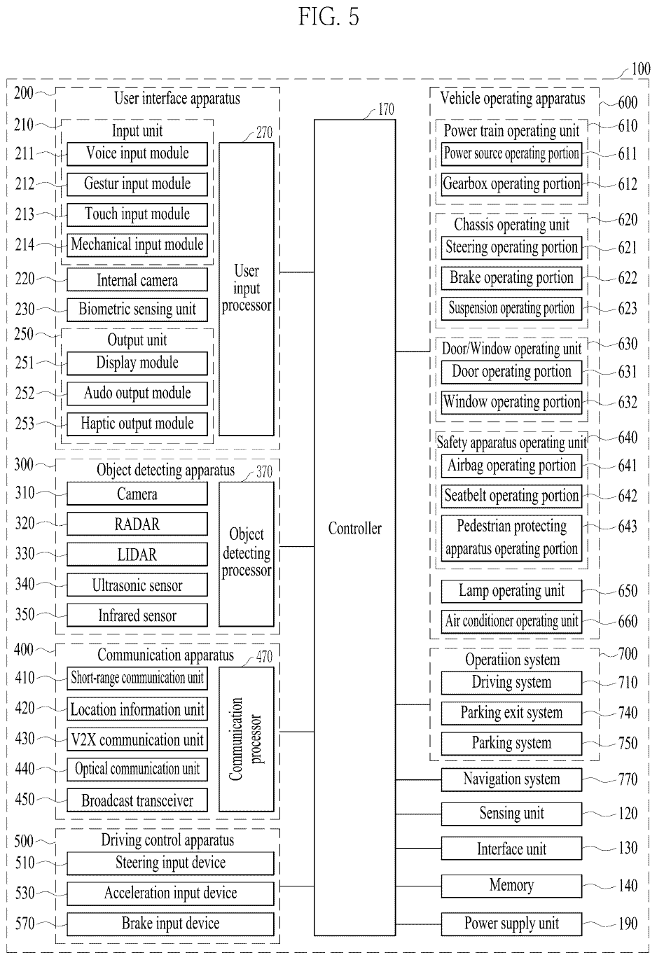

FIGS. 1 and 2 illustrate the exterior of a vehicle according to an implementation and FIGS. 3 and 4 illustrate the interior of the vehicle. FIG. 5 is a block diagram illustrating the vehicle in accordance with the implementation.

As illustrated in FIGS. 1 to 5, a vehicle 100 may include wheels turning by a driving force, and a steering input device 510 for adjusting a driving (traveling, ongoing, moving) direction of the vehicle 100.

The vehicle 100 may be an autonomous vehicle. The vehicle 100 may be switched into an autonomous mode or a manual mode based on a user input. For example, the vehicle may be switched from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300. For example, the vehicle 100 may be switched from the manual mode into the autonomous mode or from the autonomous module into the manual mode based on driving environment information generated in the object detecting apparatus 300. In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700. For example, the autonomous vehicle 100 may be driven based on information, data or signal generated in a driving system 710, a parking exit system 740, or a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width from the left side to the right side of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100

As illustrated in FIG. 5, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

In some implementations, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 100 may implement user interfaces (UIs) or user experiences (UXs) through the user interface apparatus 200.

The user interface apparatus 200 may include an input unit 210, an internal camera 220, a biometric sensing unit 230, an output unit 250 and a user interface processor 270. In some implementations, the user interface apparatus 200 may include more components in addition to components to be explained in this specification or may not include some of those components to be explained in this specification.

The input unit 210 may allow the user to input information. Data collected in the input unit 210 may be analyzed by the user interface processor 270 and processed as a user's control command.

The input unit 210 may be disposed inside the vehicle. For example, the input unit 210 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include a voice input module 211, a gesture input module 212, a touch input module 213, and a mechanical input module 214.

The audio input module 211 may convert a user's voice input into an electric signal. The converted electric signal may be provided to the user interface processor 270 or the controller 170. The voice input module 211 may include at least one microphone.

The gesture input module 212 may convert a user's gesture input into an electric signal. The converted electric signal may be provided to the user interface processor 270 or the controller 170.

The gesture input module 212 may include at least one of an infrared sensor and an image sensor for detecting the user's gesture input. According to embodiments, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method, or a disparity method.

The touch input module 213 may convert the user's touch input into an electric signal. The converted electric signal may be provided to the user interface processor 270 or the controller 170.

The touch input module 213 may include a touch sensor for detecting the user's touch input. According to an embodiment, the touch input module 213 may be integrated with the display module 251 so as to implement a touchscreen. The touchscreen may provide an input interface and an output interface between the vehicle 100 and the user.

The mechanical input module 214 may include at least one of a button, a dome switch, a jog wheel, and a jog switch. An electric signal generated by the mechanical input module 214 may be provided to the user interface processor 270 or the controller 170. The mechanical input module 214 may be arranged on a steering wheel, a center fascia, a center console, a cockpit module, a door, and the like.

The internal camera 220 may acquire an internal image of the vehicle. The user interface processor 270 may detect a user's state based on the internal image of the vehicle. The user interface processor 270 may acquire information related to the user's gaze from the internal image of the vehicle. The user interface processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, audible, or tactile signal. The output unit 250 may include at least one of a display module 251, an audio output module 252 and a haptic output module 253.

The display module 251 may output graphic objects corresponding to various types of information. The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touchscreen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window. The transparent display may have a predetermined degree of transparency and output a predetermined screen thereon. The transparent display may include at least one of a thin film electroluminescent (TFEL), a transparent OLED, a transparent LCD, a transmissive transparent display, and a transparent LED display. The transparent display may have adjustable transparency.

Meanwhile, the user interface apparatus 200 may include a plurality of display modules 251a to 251g. The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 may convert an electric signal provided from the user interface processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The user interface processor 270 may control an overall operation of each unit of the user interface apparatus 200. In some implementations, the user interface apparatus 200 may include a plurality of processors 270 or may not include any user interface processor 270.

When the user interface processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle. The user interface apparatus 200 may operate according to the control of the controller 170.

The object detecting apparatus 300 is an apparatus for detecting an object located at outside of the vehicle 100. The object may be a variety of objects associated with driving (operation) of the vehicle 100. An object may include a traffic lane, another vehicle, a pedestrian, a two-wheeled vehicle, traffic signals, light, a road, a structure, a speed hump, a terrain, an animal, and the like.

Objects may be classified into a moving object and a fixed object. For example, the moving object may be a concept including another vehicle and a pedestrian.

The object detecting apparatus 300 may include a camera 310, a radar 320, a LiDAR 330, an ultrasonic sensor 340, an infrared sensor 350, and an object detection processor 370.

In some implementations, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk, or a tail gate.

For example, the camera 310 may be disposed adjacent to at least one of side windows within the vehicle to acquire a side image of the vehicle. Or, the camera 310 may be disposed adjacent to a side mirror, a fender, or a door.

The camera 310 may provide an acquired image to the object detection processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift keying (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The object detection processor 370 may control an overall operation of each unit of the object detecting apparatus 300.

The object detection processor 370 may detect an object based on an acquired image, and track the object. The object detection processor 370 may execute operations, such as a calculation of a distance from the object, a calculation of a relative speed with the object and the like, through an image processing algorithm.

The object detection processor 370 may detect an object based on a reflected electromagnetic wave which an emitted electromagnetic wave is reflected from the object, and track the object. The object detection processor 370 may execute operations, such as a calculation of a distance from the object, a calculation of a relative speed with the object and the like, based on the electromagnetic wave.

The object detection processor 370 may detect an object based on a reflected laser beam which an emitted laser beam is reflected from the object, and track the object. The object detection processor 370 may execute operations, such as a calculation of a distance from the object, a calculation of a relative speed with the object and the like, based on the laser beam.

The object detection processor 370 may detect an object based on a reflected ultrasonic wave which an emitted ultrasonic wave is reflected from the object, and track the object. The object detection processor 370 may execute operations, such as a calculation of a distance from the object, a calculation of a relative speed with the object and the like, based on the ultrasonic wave.

The object detection processor 370 may detect an object based on reflected infrared light which emitted infrared light is reflected from the object, and track the object. The object detection processor 370 may execute operations, such as a calculation of a distance from the object, a calculation of a relative speed with the object and the like, based on the infrared light.

In some implementations, the object detecting apparatus 300 may include a plurality of object detection processors 370 or may not include any object detection processor 370. For example, each of the camera 310, the radar 320, the LiDAR 330, the ultrasonic sensor 340 and the infrared sensor 350 may each include a corresponding processor in an individual manner.

When the object detection processor 370 is not included in the object detecting apparatus 300, the object detecting apparatus 300 may operate according to the control of a processor of another apparatus within the vehicle 100 or the controller 170.

The object detecting apparatus 400 may operate according to the control of the controller 170.

The communication apparatus 400 is an apparatus for performing communication with an external device. Here, the external device may be another vehicle, a mobile terminal, or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a communication processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal, and a data broadcast signal.

The communication processor 470 may control an overall operation of each unit of the communication apparatus 400.

According to an embodiment, the communication apparatus 400 may include a plurality of communication processors 470 or may not include any communication processor 470.

When the communication processor 470 is not included in the communication apparatus 400, the communication apparatus 400 may operate according to the control of a processor of another apparatus within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 may be configured in the form of a wheel allowing a steering input in a rotating manner. In some implementations, the steering input device may also be configured in a shape of a touchscreen, a touch pad, or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. In some implementations, the acceleration input device or the brake input device may also be configured in a shape of a touchscreen, a touch pad, or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque, and the like of the motor according to the control of the controller 170.

The gearbox operating portion 612 may perform a control for a gearbox. The gearbox operating portion 612 may adjust a state of the gearbox. The gearbox operating portion 612 may change the state of the gearbox into drive (forward) (D), reverse (R), neutral (N) or parking (P).

In some examples, when an engine is the power source, the gearbox operating portion 612 may adjust a locked state of a gear in the drive (D) state.

The chassis operating unit 620 may control an operation of a chassis device. The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road. Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a vehicle operating processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include an operating processor. Each unit of the operation system 700 may individually include a processor.

In some implementations, the operation system may be implemented by the controller 170 when it is implemented in a software configuration.

In some implementations, the operation system 700 may be implemented by at least one of the user interface apparatus 200, the object detecting apparatus 300, the communication apparatus 400, the vehicle operating apparatus 600 and the controller 170 The driving system 710 may perform driving of the vehicle 100.

The driving system 710 may receive navigation information from a navigation system 770, transmit a control signal to the vehicle operating apparatus 600, and perform driving of the vehicle 100. The driving system 710 may receive object information from the object detecting apparatus 300, transmit a control signal to the vehicle operating apparatus 600 and perform driving of the vehicle 100. The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot. The parking exit system 740 may receive object information from the object detecting apparatus 300, transmit a control signal to the vehicle operating apparatus 600 and perform the exit of the vehicle 100 from the parking lot. The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100. The parking system 750 may receive object information from the object detecting apparatus 300, transmit a control signal to the vehicle operating apparatus 600 and park the vehicle 100. The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a navigation processor. The memory may store the navigation information. The navigation processor may control an operation of the navigation system 770.

According to embodiments, the navigation system 770 may update prestored information by receiving information from an external device through the communication apparatus 400.

In some implementations, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

In some examples, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive, and the like in a hardware configuration. The memory 140 may store various data for overall operations of the vehicle 100, such as programs for processing or controlling the controller 170.

In some implementations, the memory 140 may be integrated with the controller 170 or implemented as a sub component of the controller 170.

The controller 170 may control an overall operation of each unit of the vehicle 100. The controller 170 may be referred to as an electronic control unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

The vehicle 100 may communicate with an external device such as a driver's mobile device (e.g., a smartphone), receive an execution screen of an application executed in the external device, and display it on a touchscreen of the vehicle 100. Also, the vehicle 100 may transmit information on a user's touch gesture inputted on the touchscreen to the smartphone.

To this end, a vehicle display device provided in the vehicle 100 may communicate with the external device. That is, the vehicle display device may include a “vehicle external device interworking client” for communicating with and interworking with external devices. The “vehicle external device interworking client” may also be abbreviated as a “vehicle client.” The vehicle client may be implemented in software through the various components (for example, the user interface device 200, the communication device 400, the memory 140 and the like) described in FIG. 5. Certainly, the vehicle client may be implemented in hardware.

Meanwhile, when the vehicle display device includes a touchscreen, the vehicle display device may include a gesture recognizer for recognizing a touch gesture inputted on the touchscreen. The gesture recognizer may be implemented in software through the various components (for example, the user interface processor 270, the controller 170, etc.) described in FIG. 5. The gesture recognizer may be configured in hardware of the touchscreen.

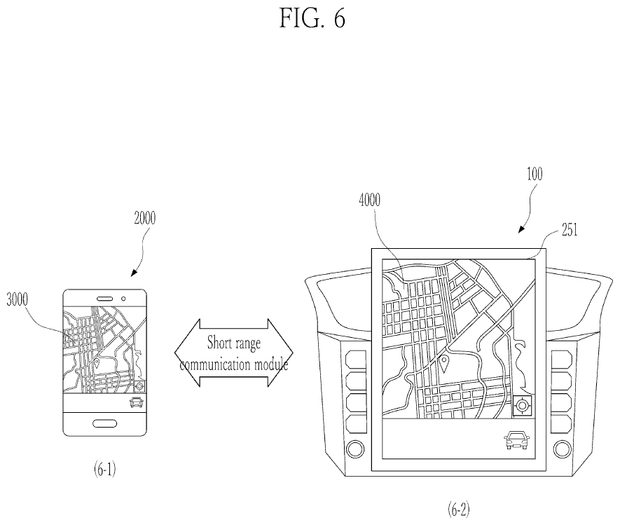

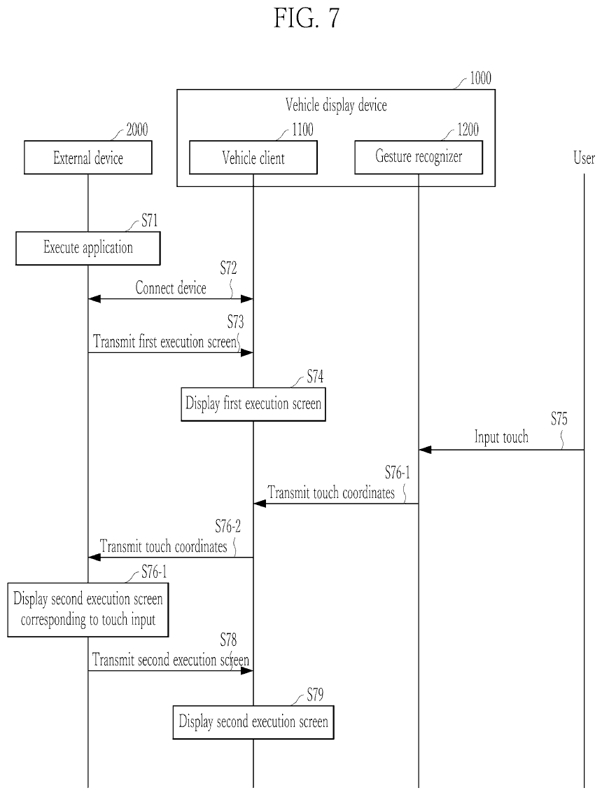

A mutual operation between the vehicle display device and the external device will be described with reference to FIGS. 6 and 7. FIG. 6 illustrates that an application execution screen of an external device is transmitted to a vehicle display device and displayed thereon, according to an embodiment of the present disclosure. Also, FIG. 7 illustrates a flowchart of a mutual operation between the vehicle display device and the external device, according to an embodiment of the present disclosure.

An application may be executed in the external device 2000 [S71]. The application may be executed through a user manipulation on the external device 2000. Accordingly, as shown in FIG. 6(6-1), the external device 2000 may display an execution screen 3000 of the application. Hereinafter, it will be assumed that the executed application is a navigation application. However, the executed application need not be limited to the navigation application, and may be another application (e.g., a music playback application). The displayed application execution screen 3000 will be referred to as “a first execution screen”.

Then, communication may be connected between the vehicle display device 1000 of the vehicle 100 and the external device 2000 [S72]. For example, the connected communication may be short-range communication (e.g., Bluetooth, etc.), but is not limited thereto.

Unlike FIG. 7, after the communication is connected between the vehicle display device 1000 and the external device 2000, the application may be executed in the external device 2000. In this case, the application may be executed through a user manipulation on the external device 2000, or the external device 2000 may execute the application in response to a control signal received from the vehicle display device 1000 through the short range communication.

The external device 2000 may transmit the first execution screen 3000 to the vehicle display device 1000 through the short-range communication [S73].

The vehicle client 1100 of the vehicle 100 may receive the first execution screen and display the first execution screen on the display unit 251 of the vehicle 100 as shown in FIG. 6(6-2) [S74]. Hereinafter, for convenience of description, it will be assumed that the display unit 251 is a touchscreen. However, it is not necessary that the display unit 251 is configured as a touchscreen. The touch input unit 213 (for example, a touch panel) may be provided separately from the display unit 251.

A first execution screen 4000 displayed on the touchscreen 251 of the vehicle 100 may be a mirroring of the first execution screen 3000 displayed on the external device 2000. Alternatively, the first execution screen 4000 displayed on the touchscreen 251 of the vehicle 100 may be formed by rendering the first execution screen 3000 displayed in the external device 2000 to meet the specifications of the touchscreen 251 of the vehicle 100 and/or the operating system specifications of the vehicle client 1100.

A user may input a touch gesture on the touchscreen 251 while looking at the first execution screen [S75].

The inputted touch gesture is transmitted to the gesture recognizer 1200, and the gesture recognizer 1200 may recognize coordinates of the inputted touch gesture. The coordinates of the recognized touch gesture may be position coordinates of a series of touches performed on the touchscreen 251 to perform the touch gesture. The coordinates of the touch gesture may be transmitted to the external device 2000 through the vehicle client 1100 [S76-1 and S76-2].

The external device 2000 may analyze the transmitted coordinates of the touch gesture to identify the touch gesture inputted by the user in the vehicle 100, recognize the identified touch gesture as a user command for the external device 2000, execute the user command with respect to the currently executed application, and display an execution screen of the application reflecting the executed user command [S77]. The executed application execution screen will be referred to as a “second execution screen”. That is, the first execution screen may be updated to the second execution screen in the external device 2000 in response to the identified touch gesture. The user command according to the identified touch gesture need not necessarily be for the currently executed application. According to the user command according to the identified touch gesture, the external device 2000 may execute a different application and display an execution screen of the different application as a second execution screen.

The external device 2000 may transmit the second execution screen to the vehicle 100, that is, the vehicle display device 1000, through the short-range communication [S78].

The vehicle client 1100 of the vehicle 100 may receive the second execution screen and display the second execution screen on the display unit 251 of the vehicle 100 [S79]. That is, the first execution screen may be updated to the second execution screen on the display unit 251 of the vehicle 100.

A second execution screen displayed on the touchscreen 251 of the vehicle 100 may be a mirroring of the second execution screen displayed on the external device 2000. Alternatively, the second execution screen displayed on the touchscreen 251 of the vehicle 100 may be formed by rendering the second execution screen displayed in the external device 2000 to meet the specifications of the touchscreen 251 of the vehicle 100 and/or the operating system specifications of the vehicle client 1100.

In the case of FIG. 7, all touch gestures inputted from the vehicle are transmitted to the gesture recognizer 1200, and the gesture recognizer 1200 needs to recognize coordinates of all the inputted touch gestures and transmit the coordinates to the external device 2000. That is, in the case of FIG. 7, information on all touch gestures inputted from the vehicle 100 needs to be transmitted to the external device 2000.

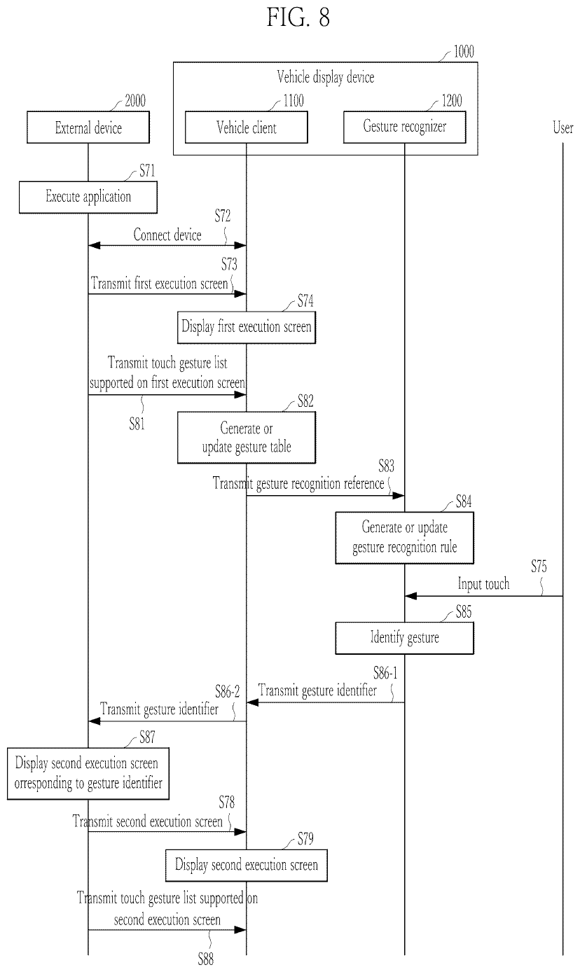

However, information on all touch gestures inputted from the vehicle 100 does not necessarily have to be transmitted to the external device 2000. This will be described further with reference to FIG. 8. FIG. 8 is a flowchart illustrating a mutual operation between the vehicle display device and the external device according to an embodiment of the present disclosure.

The external device 2000 may execute an application and display an execution screen 3000 of the application [S71].

Next, short-range communication may be connected between the vehicle 100 (or the vehicle display device 1000) and the external device 2000 [S72]. Unlike FIG. 7, after the short-range communication is connected between the vehicle 100 and the external device 2000, the application may be executed in the external device 2000.

The external device 2000 may transmit the first execution screen 3000 to the vehicle 100 through the short-range communication [S73].

The vehicle client 1100 of the vehicle 100 may receive a first execution screen and display the first execution screen on the display unit 251 of the vehicle 100 [S74].

Since the steps S71 to S74 are the same as those described in FIG. 7, detailed descriptions thereof will be omitted for simplicity of the present disclosure.

When the first execution screen is being displayed, the external device 2000 may transmit a list of touch gestures that may be recognized or allowed as remote control in the vehicle 100 to the vehicle 100 [S81]. It is assumed that a first touch gesture (e.g., “multi-tap”), a second touch gesture (e.g., “touch & hold”), a third touch gesture (e.g., “swipe”), and a fourth touch gesture (e.g., “pinch”) are listed in the list of touch gestures. That is, when the external device 2000 is displaying the first execution screen, only the first to fourth touch gestures may be recognized through remote control by the vehicle 100 and other touch gestures may not be recognized. It is obvious that examples of the respective touch gestures are intended only to help understanding of the present disclosure and need not be limited thereto. The touch gesture list may include touch characteristics of each touch gesture and an identifier thereof.

In FIG. 8, the step S81 is illustrated as performed separately from the step S73, but the step S81 may be performed together with the step S73.

The vehicle client 1100 may generate the transmitted touch gesture list as a gesture table, or update the existing gesture table to the transmitted touch gesture list [S82]. That is, the generated or updated gesture table may have a different data format from the touch gesture list, but its contents may be understood as substantially the same.

The vehicle client 1100 may transmit a gesture recognition reference corresponding to the gesture table to the gesture recognizer 1200 [S83]. That is, the vehicle client 1100 may transmit a gesture recognition reference for recognizing only first to fourth touch gestures to the gesture recognizer 1200. The gesture recognition reference may be the same as the touch gesture list or may be a transformation of the touch gesture list.

Then, the gesture recognizer 1200 may generate a gesture recognition rule for recognizing only the first to fourth touch gestures using the transmitted touch gesture reference, or may update the existing gesture recognition rule to a gesture recognition rule for recognizing only the first to fourth touch gestures [S84].

A user may input a touch gesture on the touchscreen 251 while looking at the first execution screen [S75].

The inputted touch gesture is transmitted to the gesture recognizer 1200, and the gesture recognizer 1200 may identify whether the inputted touch gesture corresponds to one of the first to fourth touch gestures using the gesture recognition rule [S85].

If the inputted touch gesture does not correspond to any one of the first to fourth touch gestures, the gesture recognizer 1200 may ignore the inputted touch gesture.

However, if the inputted touch gesture corresponds to any one of the first to fourth touch gestures, the gesture recognizer 1200 may transmit an identifier of the corresponding touch gesture to the external device 2000 through the vehicle client 1100 [S86-1 and S86-2].

The external device 2000 may execute a user command corresponding to the identifier of the touch gesture, and display a second execution screen of the application reflecting the executed user command [S87]. That is, in response to receiving the identifier of the touch gesture, the first execution screen may be updated to the second execution screen in the external device 2000. The user command corresponding to the identifier of the touch gesture need not necessarily be for the application being executed. According to the user command corresponding to the identifier of the touch gesture, the external device 2000 may execute a different application, and display an execution screen of the different application as a second execution screen.

The external device 2000 may transmit the second execution screen to the vehicle 100 through the short-range communication [S78].

The vehicle client 1100 of the vehicle 100 may receive the second execution screen and display the second execution screen on the display unit 251 of the vehicle 100 [S79]. That is, the first execution screen may be updated to the second execution screen on the display unit 251 of the vehicle 100.

The external device 2000 may transmit a list of touch gestures supported on the second execution screen to the vehicle 100 [S88].

In FIG. 8, the step S88 is illustrated as being performed separately from the step S78, but the step S88 may be performed together with the step S78.

When the list of touch gestures supported on the second execution screen is the same as the list of touch gestures supported on the first execution screen, the external device 2000 may not transmit the list of touch gestures supported on the second execution screen to the vehicle 100.

After the step S88, the steps after the step S82 may be repeated.

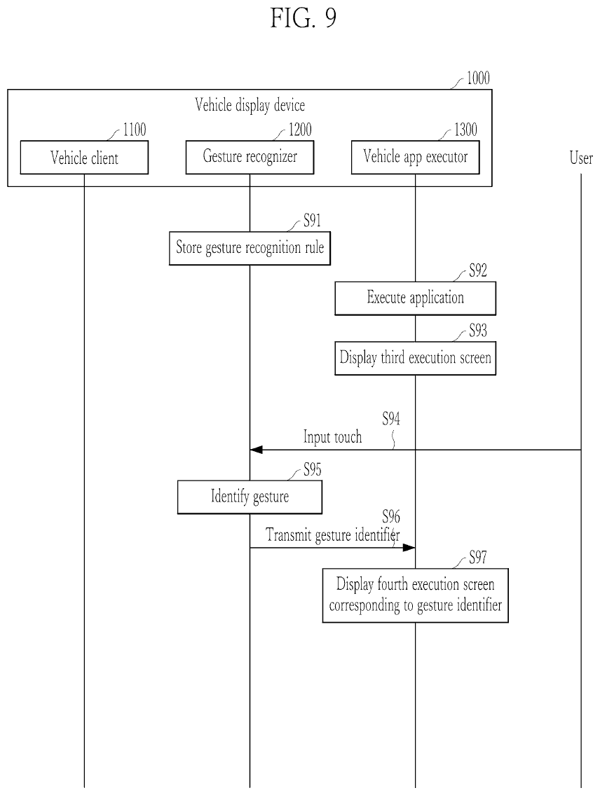

Meanwhile, the vehicle display device 1000 may display an execution screen of an application installed and executed in the vehicle 100 or the vehicle display device itself after the interworking with the external device 2000 is executed. This will be described further with reference to FIG. 9. FIG. 9 is a flowchart illustrating an operation of a vehicle display device according to an embodiment of the present disclosure.

The vehicle display device 1000 may further include a vehicle application executor 1300 for executing at least one application (hereinafter, referred to as a “vehicle application”) installed on the vehicle 100 or the vehicle display device 1000 itself. The vehicle application executor 1300 may be implemented in software through the various components (for example, the user interface device 200, the communication device 400, the memory 140, the controller 170, etc.) described in FIG. 5.

The gesture recognizer 1200 may store a vehicle gesture recognition rule separately from the gesture recognition rule for the external device described in the step S84 [S91]. For example, the vehicle gesture recognition rule is stored as a factory default or updated after factory shipment, and may be based on a predefined gesture recognition reference so as to recognize a user's touch gesture inputted through the touchscreen of the vehicle 100 when the vehicle application is executed. The vehicle gesture recognition rule may be at least partially different from the gesture recognition rule for the external device.

The vehicle application executor 1300 may execute the vehicle application [S92]. The vehicle application may be executed by a user manipulation on the vehicle display device 1000.

As the vehicle application is executed, the vehicle application executor 1300 may display an execution screen of the vehicle application, that is, a third execution screen, on the touchscreen [S93]. In the third execution screen, “third” is only named to be distinguished from the first execution screen and the second execution screen and does not represent any display order relationship therebetween.

A user may input a touch gesture on the touchscreen 251 while looking at the third execution screen [S94].

The inputted touch gesture is transmitted to the gesture recognizer 1200, and the gesture recognizer 1200 may identify whether the inputted touch gesture corresponds to a predefined touch gesture for the executed vehicle application using the vehicle gesture recognition rule [S95].

If the inputted touch gesture does not match the predefined touch gesture, the gesture recognizer 1200 may ignore the inputted touch gesture.

However, if the inputted touch gesture matches the predefined touch gesture, the gesture recognizer 1200 may transmit an identifier of the matching touch gesture to the vehicle application executor 1300 [S96].

The vehicle application executor 1300 may execute a user command corresponding to the identifier of the touch gesture, and display a fourth execution screen of the application reflecting the executed user command [S97]. That is, in response to receiving the identifier of the touch gesture, the third execution screen may be updated to the fourth execution screen in the external device 2000. The user command corresponding to the identifier of the touch gesture does not necessarily have to be related to the currently executed vehicle application. According to the user command corresponding to the identifier of the touch gesture, the vehicle application executor 1300 may execute a different vehicle application, and display an execution screen of the different application as a fourth execution screen.

As described in FIGS. 7 and 8, the user's touch gesture performed on the touchscreen of the vehicle may be shared with the external device 2000 and used for remote control of an application executed in the external device 2000 (hereinafter referred to as an “external device application”). In addition, as shown in FIG. 9, the user's touch gesture performed on the touchscreen of the vehicle may be used for control of the vehicle application executed in the vehicle application executor 1300.

However, although it is intended to execute the same operation or function (e.g., zoom control), a touch gesture predefined for the same operation or function in the external device application may differ from a touch gesture predefined for the same operation or function in the vehicle application.

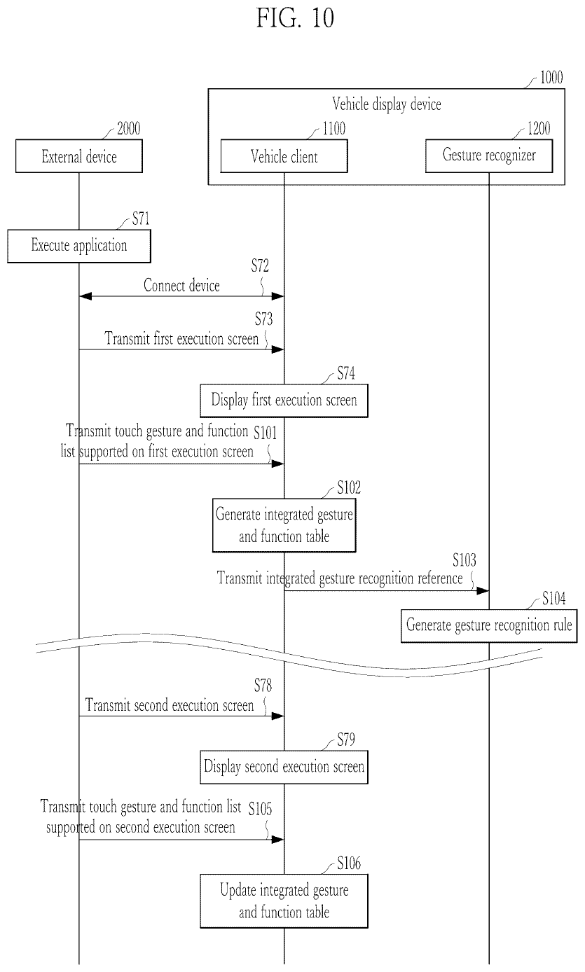

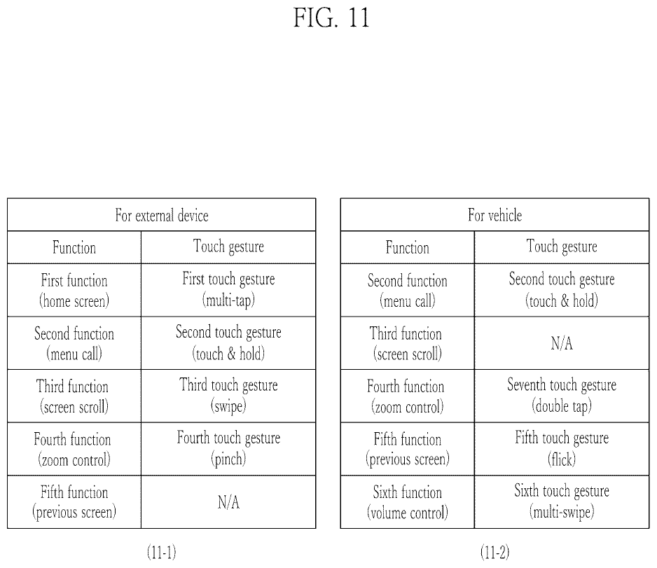

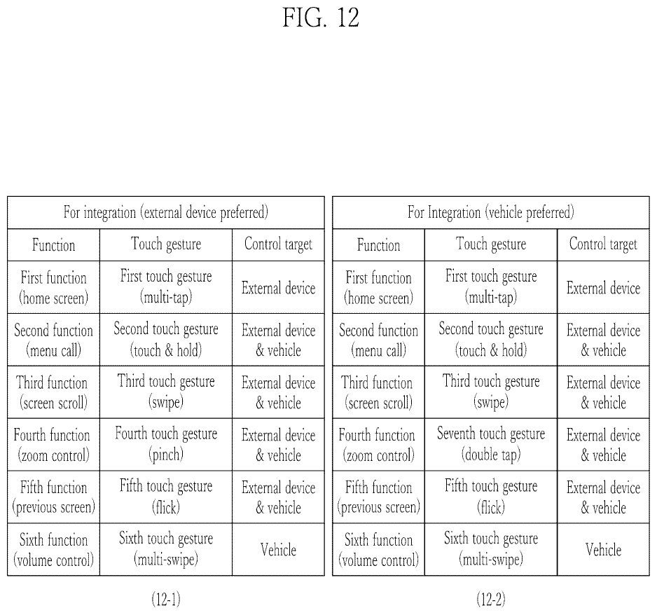

Hereinafter, by further referring to FIGS. 10 to 12, a method for mutually unifying the predefined touch gesture for the same operation or function in the external device application and the predefined touch gesture for the same operation or function in the vehicle application will be described. FIG. 10 is a flowchart illustrating a mutual operation between a vehicle display device and an external device according to an embodiment of the present disclosure. FIGS. 11 and 12 illustrate examples of functions and touch gestures according to FIG. 10.

The external device 2000 may execute an external device application and display a first execution screen of the external device application [S71].

Next, short-range communication may be connected between the vehicle 100 (or the vehicle display device 1000) and the external device 2000 [S72]. Unlike FIG. 10, after the short-range communication is connected between the vehicle 100 and the external device 2000, the external device application may be executed in the external device 2000.

The external device 2000 may transmit the first execution screen of the external device application to the vehicle 100 through the short-range communication [S73].

The vehicle client 1100 of the vehicle 100 may receive the first execution screen and display the first execution screen on the display unit 251 of the vehicle 100 [S74].

Since the steps S71 to S74 are the same as those described in FIG. 7, detailed descriptions thereof will be omitted for simplicity of the present disclosure.

The external device 2000 may transmit a list of functions and touch gestures supported by the external device to the vehicle 100 while the first execution screen is being displayed [S101]. Although FIG. 10 shows that the step S101 is performed separately from the step S73, the step S101 may also be performed together with the step S73.

Using the transmitted list of the functions and touch gestures, the vehicle client 1100 may generate an integrated gesture and function table that may be used not only for the external device 2000 but also for the vehicle application executor 1300 [S102].

The integrated gesture and function table will be described further with reference to FIG. 11.

FIG. 11 (11-1) is an example of a list of functions and touch gestures that may be received from the external device. In the list of the function and the touch gesture, a function supported by the external device is added to the above-described touch gesture list. Although not shown, an identifier of each function may be additionally included in the list. It may be understood as a combination of a function list of the list for the function and the touch gesture and a touch gesture list corresponding thereto.

As shown in FIG. 11 (11-1), the external device 2000 may allow remote control by the vehicle 100 for a first function (e.g., “home screen”), a second function (e.g., “menu call”), a third function (e.g., “screen scroll”), a fourth function (e.g., “zoom control”), and a fifth function (e.g., “previous screen”) while a first execution screen is being displayed. It is obvious that examples of the respective functions are only intended to help the understanding of the present disclosure and need not be limited thereto. It is a matter of course that remote control by the vehicle 100 may be allowed for fewer or more functions.

In addition, in the external device 2000, as user commands for executing the first function, the second function, the third function, and the fourth function, respectively, a first touch gesture (e.g., “multi-tap”), a second touch gesture (e.g., “touch & hold”), a third touch gesture (e.g., “swipe”), and a fourth touch gesture (e.g., “pinch”) may be matched thereto. That is, in the external device 2000, when the first touch gesture is inputted, the first function may be executed. When the second touch gesture is inputted, the second function may be executed. When the third touch gesture is inputted, the third function may be executed. When the fourth touch gesture is inputted, the fourth function may be executed. The examples for the respective touch gestures are only intended to help the understanding of the present disclosure and need not be limited thereto.

Some touch gesture may not be matched to a fifth function. In order to remotely execute the fifth function, a separate key button of the vehicle display device 1000 may have to be manipulated. This is only an example, and it is a matter of course that some touch gesture may be matched to the fifth function.

Meanwhile, FIG. 11 (11-2) is an example of a list of functions and touch gestures supported when an execution screen of the vehicle application is being displayed on the vehicle display device 1000, and may be stored as a default at the factory shipment of the vehicle 100 or updated after the factory shipment. Although not shown, the list may additionally include a touch characteristic of each touch gesture, an identifier thereof, and an identifier of each function. The list of the function and the touch gesture may also be understood as a combination of a function list and a touch gesture list corresponding thereto.

As shown in FIG. 11 (11-2), the vehicle display device 1000 may provide a second function (e.g., “menu call”), a third function (e.g., “screen scroll”), a fourth function (e.g., “zoom control”), a fifth function (e.g., “previous screen”), and a sixth function (e.g., “volume control”). It is obvious that examples of each function are intended only to help the understanding of the present disclosure and need not be limited thereto. It is a matter of course that fewer or more functions may be executed by the vehicle display device 100.

In addition, in the vehicle display device 1000, as user commands for executing the second function, the fourth function, the fifth function, and the sixth function, respectively, a second touch gesture (e.g., “touch & hold”), a seventh touch gesture (e.g., “double tap”), a fifth touch gesture (e.g., “flick”), and a sixth touch gesture (e.g., “multi swipe”) may be matched thereto. Namely, the second function may be executed when the second touch gesture is inputted, the fifth function may be executed when the fifth touch gesture is inputted, and the sixth function may be executed when the sixth touch gesture is inputted. A certain touch gesture may not be matched to the third function. In order to execute the third function, a separate key button of the vehicle display device 1000 may have to be manipulated. This is merely an example, and it is a matter of course that a certain touch gesture may be matched to the third function. It is obvious that examples of each touch gesture are intended only to help the understanding of the present disclosure and need not be limited thereto.

Comparing (11-1) and (11-2) of FIG. 11, a touch gesture for a second function is a second touch gesture, which is the same between the external device 2000 and the vehicle display device 1000.

On the other hand, a touch gesture for a fourth function is a third touch gesture in the case of the external device 2000, but is a seventh touch gesture in the case of the vehicle display device 1000, which is different between the external device 2000 and the vehicle display device 1000.

A first function is a function that allows remote control in the external device 2000, but a function that cannot be executed in the vehicle display device 1000.

A third function is a function that allows remote control through a touch gesture (i.e., a third touch gesture) in the external device 2000, but a function that cannot be executed through a touch gesture in the vehicle display device 1000.

A fifth function is a function for which remote control is not allowed through a touch gesture in the external device 2000, but is a function that can be executed through a touch gesture (i.e., a fifth touch gesture) in the vehicle display device 1000.

A sixth function is a function for which remote control is not allowed in the external device 2000, but is a function that can be executed in the vehicle display device 1000.

In this case, as shown in FIG. 12 (12-1), the vehicle client 1100 may generate an integrated gesture and function table (or list) by prioritizing the list of functions and touch gestures received in the external device 2000 (see FIG. 11 (11-1)), and supplementing the list of functions and touch gestures (see FIG. 11 (11-2)) predefined in the vehicle display device 1000. The integrated gesture and function table can be understood as a combination of the integrated gesture list and the integrated gesture function list.

According to the integrated gesture and function table, a first touch gesture may be matched with respect to a first function for the external device 2000. That is, a control target of the first touch gesture is the external device 2000.

Therefore, when the execution screen of the external device application is being displayed in the vehicle display device 1000, when a first touch gesture is inputted through the touchscreen of the vehicle 100, the gesture recognizer 1200 may recognize the inputted gesture and transmit an identifier of the first touch gesture or a function identifier corresponding to the first touch gesture to the external device 2000. Therefore, a first function corresponding to a first touch gesture may be remotely executed in the external device 2000. However, when the execution screen of the vehicle application is being displayed in the vehicle display device 1000, if a first touch gesture is inputted through the touchscreen of the vehicle 100, the gesture recognizer 1200 may ignore it.

According to the integrated gesture and function table, second to fifth touch gestures may be matched to second to fifth functions for the external device 2000 and the vehicle 100, respectively. That is, the control targets of the second to fifth touch gestures are the external device 2000 and the vehicle 100.

Accordingly, when the execution screen of the external device application is being displayed in the vehicle display device 1000, if a desired touch gesture among the second to fifth touch gestures is inputted through the touchscreen of the vehicle 100, the gesture recognizer 1200 may recognize the same and transmit an identifier of the desired touch gesture or a function identifier corresponding to the desired touch gesture to the external device 2000. Accordingly, the function corresponding to the desired touch gesture among the second to fifth functions may be remotely executed in the external device 2000.

In addition, when the execution screen of the vehicle application is being displayed in the vehicle display device 1000, if a desired touch gesture among the second to fifth touch gestures is inputted through the touchscreen of the vehicle 100, the gesture recognizer 1200 may recognize the desired touch gesture or transmit an identifier of the desired touch gesture or a function identifier corresponding to the desired touch gesture to the vehicle application executor 1300. Accordingly, the vehicle application executor 1300 may execute a function corresponding to the desired touch gesture among the second to fifth functions.

It is important to note that a fourth touch gesture instead of a seventh touch gesture may be inputted to execute a fourth function not only when the execution screen of the external device application is being displayed, but also when the execution screen of the vehicle application is being displayed. In addition, not only when the execution screen of the above vehicle application is being displayed but also when the execution screen of the external device application is being displayed, a fifth touch gesture may be inputted for the execution of a fifth function.

According to the integrated gesture and function table, a sixth touch gesture may be matched to a sixth function for the vehicle 100. That is, a control target of the sixth touch gesture is the vehicle 100 or the vehicle display device 1000.

Accordingly, when the execution screen of the external device application is being displayed in the vehicle display device 1000, if a sixth touch gesture is inputted through the touchscreen of the vehicle 100, the gesture recognizer 1200 may ignore it. However, when the execution screen of the vehicle application is being displayed in the vehicle display device 1000, if a sixth touch gesture is inputted through the touchscreen of the vehicle 100, the gesture recognizer 1200 may recognize the inputted gesture and transmit an identifier of the sixth touch gesture or a function identifier corresponding to the sixth touch gesture to the vehicle app executor 1300. Accordingly, the vehicle app executor 1300 may execute the sixth function corresponding to the sixth touch gesture.

If the functions in the list of FIG. 11 (11-1) and the functions in the list of FIG. 11 (11-2) are the same, the control target information may be deleted from the list of FIG. 12 (12-1).

Returning to FIG. 10, the vehicle client 1100 may transmit an integrated gesture recognition reference corresponding to the integrated gesture and function table to the gesture recognizer 1200 [S103].

Then, the gesture recognizer 1200 may generate an integrated gesture recognition rule using the touch gesture recognition reference [S104].

Meanwhile, the external device 2000 may transmit a second execution screen to the vehicle 100 through the short-range communication instead of the first execution screen of the external device application [S78].

The vehicle client 1100 of the vehicle 100 may receive the second execution screen and display the second execution screen on the display unit 251 of the vehicle 100 [S79].

The external device 2000 may transmit a list of functions and touch gestures supported by the external device to the vehicle 100 while the second execution screen is being displayed [S105]. The reason for this is that when the execution screen displayed by the external device 2000 is changed, the list of functions and touch gestures supported by the external device may also be changed. For example, the fourth function (e.g., “zoom control”) may not be executed in some execution screen. Although FIG. 10 shows that the step S105 is performed separately from the step S78, the step S105 may also be performed together with the step S78.

The vehicle client 1100 may update the integrated gesture and function table that may be used not only for the external device 2000 but also for the vehicle application executor 1300 using the transmitted list of the function and touch gesture [S106].

Since the step S106 is substantially the same as the step S102, a detailed description thereof will be omitted.

In the FIG. 12 (12-1), the integrated gesture and function table is generated by prioritizing the list ((11-1) of FIG. 11) of functions and touch gestures received by the external device 2000 and supplementing the list ((11-2) of FIG. 11) of functions and touch gestures predefined in the vehicle display device 1000. However, the integrated gesture and function table may be generated by prioritizing the list ((11-2) of FIG. 11) of functions and touch gestures predefined in the vehicle display device 1000 and supplementing the list ((11-1 of FIG. 11) of the function and touch gesture received in the external device 2000. In this case, an integrated gesture and function table as shown in FIG. 12 (12-2) may be generated. According to this, a seventh touch gesture instead of a fourth touch gesture may be inputted for execution of a fourth function not only when the execution screen of the vehicle application is being displayed but also when the execution screen of the external device application is being displayed.

The priority between the external device 2000 and the vehicle 100 may be manually determined by a user's setting, or may be automatically determined in the vehicle display device 1000 according to a predetermined reference. The predetermined reference may be determined by which of the execution screen of the external device application and the execution screen of the vehicle application is more used (for example, a display time in the display unit), but is not limited thereto.

A list of functions and touch gestures supported by the external device may vary according to any one of a model of the external device connected to the vehicle display device 1000, a type of application executed in the external device, and an execution screen of the application. Whenever any one of them is changed, the integrated gesture and function table may vary.

Meanwhile, communication between the external device 2000 and the vehicle display device 1000 may be released after the integrated gesture and function table is generated or updated. In this case, the gesture recognizer 1200 may continue to apply the integrated gesture recognition rule even though the communication is released. Alternatively, when the communication is released, the vehicle client 1100 may apply the vehicle gesture recognition rule instead of the integrated gesture recognition rule.

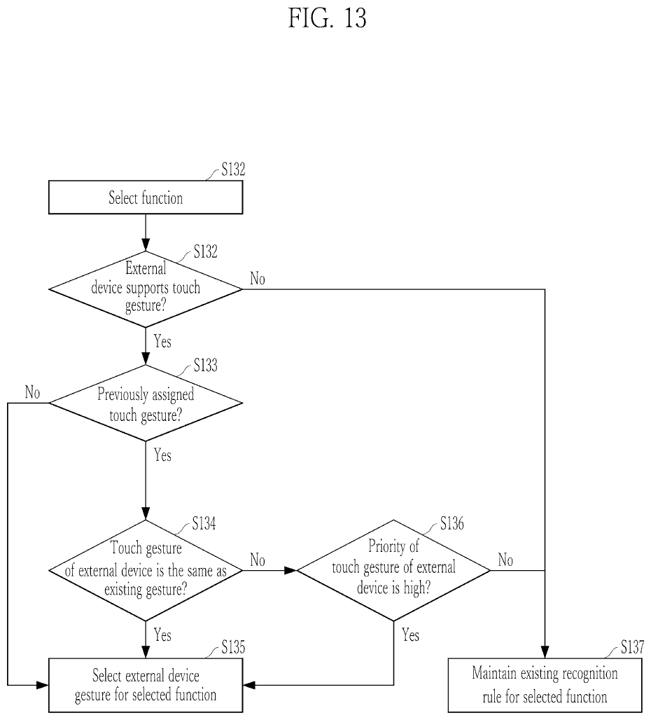

Hereinafter, a process of generating the integrated zester recognition rule will be described further with reference to FIG. 13. FIG. 13 is a flowchart illustrating generation of the integrated gesture recognition rule of FIG. 12.

First, a single function may be selected from all the functions mentioned in FIGS. 11 and 12 [S131].

It may be determined whether there is a touch gesture supported by the external device 2000 for the selected function [S132].

When there is no touch gesture supported by the external device 2000 for the selected function as a result of the determination in the step S132, an existing recognition rule for the selected function in the vehicle display device 1000 may be maintained. This is the same case as the fifth and sixth functions of FIG. 12.

However, as a result of the determination in the step 132, if there is a touch gesture supported by the external device 2000 for the selected function, it may be determined whether there is a touch gesture supported by the vehicle display device 1000 for the selected function [S133].

As a result of the determination of the step S133, when there is no touch gesture supported by the vehicle display device 1000 for the selected function, a touch gesture supported by the external device for the selected function may be adopted [S135]. This is the same case as the first and third functions of FIG. 12.

However, as a result of the determination of the step S133, if there is no touch gesture supported by the vehicle display device 1000 for the selected function, it may be determined whether the touch gesture supported by the external device 2000 and the touch gesture supported by the vehicle display device 1000 are the same for the selected function [S134].

As a result of the determination of the step S134, when the touch gesture supported by the external device 2000 and the touch gesture supported by the vehicle display device 1000 are the same for the selected function, the touch gesture supported by the external device may be adopted for the selected function [S135]. This is the same case as the second function of FIG. 12.

However, as a result of the determination of the step S134, if the touch gesture supported by the external device 2000 and the touch gesture supported by the vehicle display device 1000 are not the same for the selected function, it may be determined whether a priority of the external device 2000 is higher than that of the vehicle display device 1000 [S136].

As a result of the determination in the step S136, when the priority of the external device 2000 is higher than that of the vehicle display device 1000, a touch gesture supported by the external device for the selected function may be adopted [S135]. This is the same case as the fourth function of FIG. 12 (12-1).

However, as a result of the determination of the step S136, if the priority of the external device 2000 is lower than that of the vehicle display device 1000, a touch gesture supported by the vehicle display device 1000 may be adopted for the selected function [S137]. This is the same case as the fourth function of FIG. 12 (12-2).

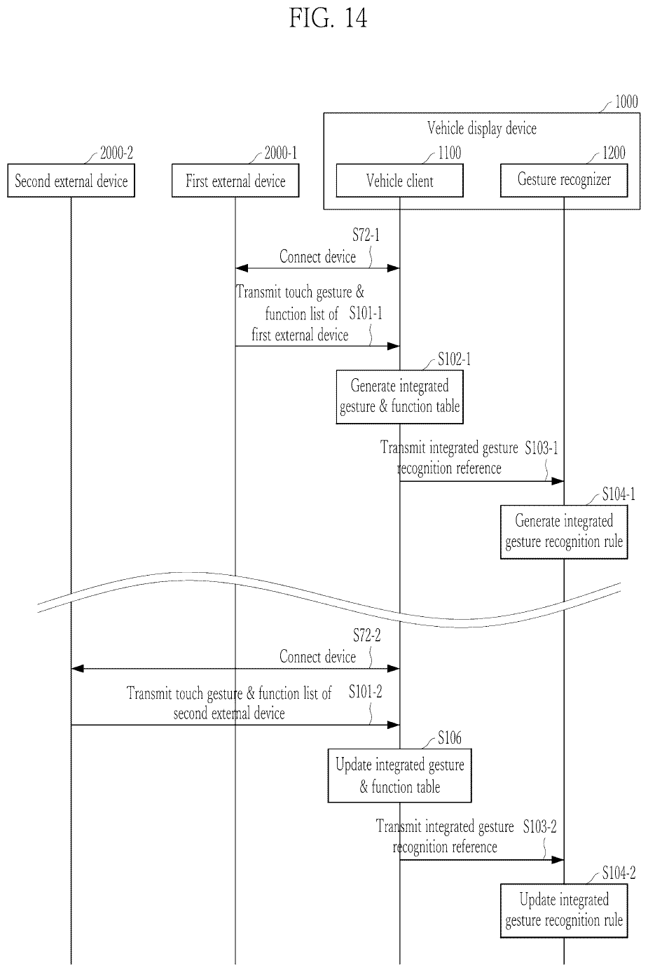

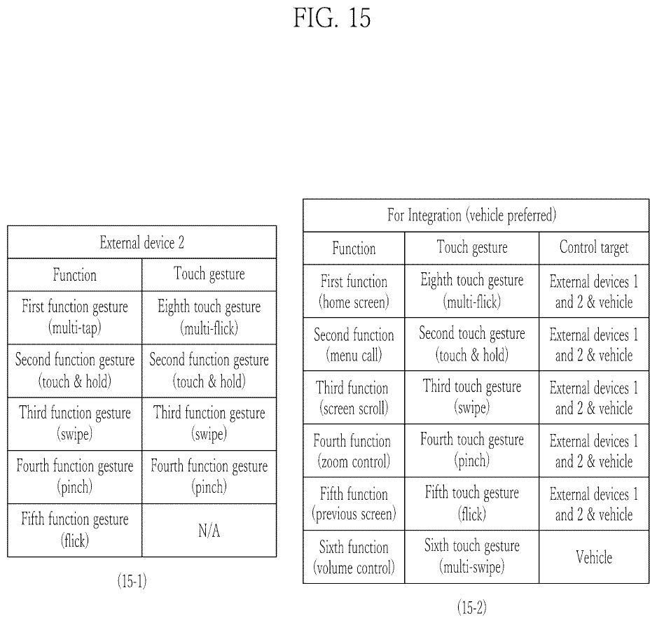

The process of unifying a touch gesture between a single external device and the vehicle has been described with reference to FIGS. 10 to 13. However, a touch gesture between a plurality of external devices and the vehicle may be unified. This will be described further with reference to FIGS. 14 and 15. FIG. 14 is a flowchart illustrating a mutual operation between a vehicle display device and a plurality of external devices according to an embodiment of the present disclosure. FIG. 15 illustrates an example of a function and a touch gesture according to FIG. 14. For simplicity of the description, FIG. 14 focuses on the viewpoint of a touch gesture and function list.

A short-range communication may be connected between the vehicle display device 1000 (or the vehicle 100) and a first external device 2000-1 [S72-1].

The first external device 2000-1 may transmit a list of functions and touch gestures supported by the first external device 2000-1 to the vehicle 100 [S101-1].

The vehicle client 1100 may generate an integrated gesture and function table that may be used for the first external device 2000-1 and the vehicle application executor 1300 using the list of functions and touch gestures of the first external device [S102-1].

The vehicle client 1100 may transmit an integrated gesture recognition reference corresponding to the integrated gesture and function table to the gesture recognizer 1200 [S103-1].

Then, the gesture recognizer 1200 may generate an integrated gesture recognition rule using the touch gesture recognition reference [S104-1].

When the first external device 2000-1 is regarded as the external device 2000, steps S72-1, S101-1, S102-1, S103-1, and S104-1 of FIG. 14 are substantially overlapped with the steps S72, S101, S102, S103, and S104 of FIG. 10, and thus a detailed description thereof will be omitted.

Next, a short-range communication may be connected between the vehicle display device 1000 (or the vehicle 100) and a second external device 2000-2 [S72-2]. The step S72-2 may be performed in a state in which the short-range communication between the vehicle display device 1000 and the first external device 2000-1 is maintained, or may be performed after the short-range communication is released.

The second external device 2000-2 may transmit a list of functions and touch gestures supported by the second external device 2000-2 to the vehicle 100 [S101-2].

The vehicle client 1100 may generate an integrated gesture and function table that may be used for the first external device 2000-1, the second external device 2000-2, and the vehicle application executor 1300 using the list of functions and touch gestures of the second external device [S102-1].

The vehicle client 1100 may transmit an integrated gesture recognition reference corresponding to the integrated gesture and function table to the gesture recognizer 1200 [S103-1].

Then, the gesture recognizer 1200 may generate an integrated gesture recognition rule using the touch gesture recognition reference [S104-1].

Steps S72-2, S101-2, S103-2, and S104-2 except for step S106 of FIG. 14 are substantially overlapped with the steps S72, S101, S103, and S104 of FIG. 10, and thus detailed descriptions thereof will be omitted.

The step S106 of FIG. 14 will be described further with reference to FIG. 15. FIG. 15 illustrates an example of the function and the touch gesture of FIG. 14.

In FIG. 15, regarding priorities of the first external device 2000-1, the second external device 2000-2, and the vehicle 100, it is assumed that the second external device 2000-2, the vehicle 100, and the first external device 2000-1 have a highest priority, a lowest priority, and a middle priority, respectively. In this case, when the first external device 2000-1 is regarded as the external device 2000, the integrated gesture and function table generated according to the step S102-1 is the same as shown in FIG. 12 (12-1).

FIG. 15 (15-1) is an example of a list of functions and touch gestures that may be received from the second external device 2000-1.

Compared with the list of functions and touch gestures of FIG. 11 (11-1), first to fifth functions are the same. As user commands for executing second to fourth functions, respectively, touch gestures are same. Since no touch gesture is matched to the fifth function, a separate key button of the vehicle display device 1000 may have to be manipulated in order to remotely execute the fifth function. However, there is a difference in that a touch gesture as a user command for executing the first function is an eighth touch gesture (e.g., “double flick”).

As mentioned above, the priority of the first external device 2000-1 is higher than that of the vehicle 100. Accordingly, the vehicle client 1100 may update the integrated gesture and function table, as shown in FIG. 15 (15-2), in a manner of prioritizing to reflect the list of the function and touch gesture of FIG. 15 (15-1) to the integrated gesture and function table generated as shown in FIG. 12 (12-1).

In addition, when the list of functions and touch gestures of FIG. 15 (15-1) is compared with the integrated gesture and function table generated as shown in FIG. 12 (12-1), a collision occurs only in the first function. That is, in the list of the function and touch gesture of FIG. 15, the touch gesture as a user command to execute the first function is the eighth touch gesture, but in the integrated gesture and function table of FIG. 12 (12-1), the touch gesture as a user command to execute the first function is the first touch gesture.

Since the priority of the second external device 2000-2 is higher than that of each of the first external device 2000-1 and the vehicle 100, as shown in FIG. 15 (15-2), the vehicle client 1100 may update the integration gesture and function table so that the touch gesture as a user command for executing the first function is the eighth touch gesture. In addition, the vehicle client 1100 may update the integration gesture and function table so that the first to fifth functions and the touch gestures corresponding thereto may be additionally applied to the second external device 2000-2.

In the present disclosure, the case where a user command is a touch gesture inputted through the touchscreen has been described. However, the present disclosure is not limited thereto. The present disclosure described above may be applied as it is even when a user command is a motion gesture input through the gesture input unit 212. To this end, the external devices 2000, 2000-1, and 2000-2 should be able to recognize or allow a motion gesture for remote control in the vehicle 100.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include a controller of the AI device.

1. A vehicle display device, comprising:
a display unit;
a user input unit;
a vehicle client configured to receive a first execution screen of an external device application from an external device by communicating with the external device executing the external device application, display the first execution screen on the display unit, and generate an external device gesture recognition reference by receiving an external device gesture list relating to the first execution screen from the external device, and
a gesture identifier identifying a gesture inputted through the user input unit based on the external device gesture recognition reference while the first execution screen is displayed.

2. The vehicle display device of claim 1, wherein the display unit and the user input unit comprise a touchscreen, wherein the inputted gesture is a touch gesture, and wherein the external device gesture list is an external device touch gesture list.

3. The vehicle display device of claim 2, wherein based on the touch gesture related to the external device gesture recognition reference, the vehicle client transmits information on the touch gesture to the external device, receives a second execution screen of the external device application related to the touch gesture, and displays the second execution screen on the display unit.

4. The vehicle display device of claim 3, wherein the vehicle client receives an external device gesture list relating to the second execution screen.

5. The vehicle display device of claim 2, further comprising an app executor configured to execute a vehicle application and display a third execution screen of the vehicle application on the touchscreen,
wherein based on a pre-stored vehicle gesture recognition reference, the gesture recognizer identifies a touch gesture inputted through the touchscreen while the third execution screen is displayed.

6. The vehicle display device of claim 5, wherein based on the touch gesture related to the vehicle gesture recognition reference, the app executor displays a fourth execution screen of the vehicle application related to the touch gesture on the touchscreen.

7. The vehicle display device of claim 2, wherein the vehicle client further receives an external device function list relating to a function supported by the external device from the external device and
wherein at least one item of the external device function list is related to the external device touch gesture list.

8. The vehicle display device of claim 7, wherein the vehicle client generates an integrated function and touch gesture list based on the external device function list, the external device touch gesture list, a previously stored vehicle function list, and a previously stored vehicle touch gesture list and
wherein at least one item of the vehicle function list is related to the vehicle touch gesture list.

9. The vehicle display device of claim 8, wherein although any of the first execution screen of the external device application and the third execution screen of the vehicle application is displayed on the display unit, the gesture recognizer identifies a touch gesture inputted through the touchscreen based on an integrated gesture recognition reference related to the integrated function and touch gesture list.

10. The vehicle display device of claim 9, wherein the integrated function and touch gesture list further comprises information on whether each touch gesture is related to any one of the external device and the vehicle display device.

11. The vehicle display device of claim 8, wherein the integrated function and touch gesture list is differently generated according to a priority between the external device and the vehicle display device.

12. The vehicle display device of claim 11, wherein the priority is automatically set according to a comparison between a use time of an execution screen of the external device application and a use time of an execution screen of a vehicle application.

13. The vehicle display device of claim 8, wherein the integrated function and touch gesture list is generated differently according to any one of a model of the external device, a type of the external application, and an execution screen of the external application.

14. The vehicle display device of claim 9, wherein although communication between the external device and the vehicle client is released, the gesture recognizer identifies a touch gesture inputted through the touchscreen based on an integrated gesture recognition reference related to the integrated function and touch gesture list.

15. The vehicle display device of claim 9, wherein based on releasing the communication between the external device and the vehicle client, a touch gesture inputted through the touchscreen is identified based on a previously stored vehicle function list and a previously stored vehicle touch gesture list.

16. The vehicle display device of claim 8, wherein the vehicle client is configured to communicate with a different external device, receive a function list and a touch gesture list for the different external device, and update the integrated function and touch gesture list based on the received function list and the received touch gesture list.

17. The vehicle display device of claim 16, wherein with respect to the external device, the different external device, and an app executor for executing a vehicle application, the gesture recognizer identifies a touch gesture inputted through the touchscreen based on an integrated gesture recognition reference related to the updated integrated function and touch gesture list.

18. The vehicle display device of claim 9, wherein based on identifying the touch gesture inputted through the touchscreen while the first execution screen of the external device application is displayed, an identifier of the touch gesture is transmitted to the external device.

19. The vehicle display device of claim 9, wherein based on identifying the touch gesture inputted through the touchscreen while the third execution screen of the vehicle application is displayed, an identifier of the touch gesture is transmitted to an app executor executing the vehicle application.

20. A method of controlling a vehicle display device, the method comprising:
receiving to display a first execution screen of an external device application from an external device by communicating with the external device executing the external device application;
generating an external device gesture recognition reference by receiving an external device gesture list relating to the first execution screen from the external device, and
identifying a gesture inputted through a user input unit based on the external device gesture recognition reference while the first execution screen is displayed.
